(19) United States
(12) Patent Application Publication
(10) Pub. No.: US 2003/0052059 A1
(43) Pub. Date: Mar. 20, 2003

(54) Method for inhibiting filamentous bacteria bulking

(76) Inventors: Scott M. Boyette, New Hope, PA (US); Peter E. Norman, Warrington, PA (US); Kelly S. Smith, Warrington, PA (US)

Correspondence Address: Steven D. Boyd, BetzDearborn Inc., 4636 Somerton Road, Trevose, PA, 19053-6783, US

(21) Appl. No.: 09/884,419

(22) Filed: Jun. 19, 2001

(51) Int. Cl. C02F 3/12

(52) U.S. Cl. 210/631; 210/698; 210/626

(57) ABSTRACT

A method for inhibiting the adverse effects on settling and compaction in aqueous systems such as biological waste treatments systems is disclosed. The method comprises adding to the aqueous system a treatment comprised of a combination of a biologically active surfactant and a divalent metal active species. The preferred biologically active surfactants are alkyl ethoxylates. The preferred divalent active species are calcium and/or magnesium control agents such as polyepoxysuccinic acid, hydroxyethylidine diiphosphonic acid, and ethylene di tetraacetic acid

### FIELD OF THE INVENTION

The present invention relates to a method for inhibiting the adverse effects on settling and compaction in biological waste treatment systems caused by filamentous bacteria. More particularly, the present invention relates to a method of treating biological waste treatment systems such as activated sludge treatment systems to inhibit the excessive growth of filamentous bacteria while not significantly impacting the growth of desirable floc-forming microorganisms.

### BACKGROUND OF THE INVENTION

Filamentous bulking is a serious problem in many municipal and industrial biological waste treatment systems. Seasonal, waste and environmental changes can cause filamentous bacteria to bloom within these biological systems. The excessive numbers and length of filamentous strands in such blooms can result in extended floc structure (bulking) and reduced settling rates. The reduced settling rates can cause a decrease in settler performance and reduce cell age in the system. The reduced settling rates can also cause an increase in solid discharge concentrations by unwanted clarifier carry over. Typical treatments aimed at controlling bulking caused by filamentous microorganisms comprise the addition of compounds with general biocidal activity. This results in a decrease in a total number of bacteria in a system thus reducing the number of troublesome filamentous bacteria. The drawback is that some of the desirable floc-forming bacteria are killed along with the filamentous bacteria. Killing of the floc-forming bacteria responsible for the bulk bioprocessing activity in the waste treatment system is undesirable. In addition, the biocides employed such as reactive halogen or halogen-containing molecules and their release to receiving waters is undesirable. Operational changes such as altering residence times or balancing nutrient and pH profiles can create environments conducive to balanced filament/floc-forming growth. However, sometimes environmental parameters are either unobtainable in a reasonable time frame or may result in excessive discharge concentrations. An activated sludge treatment of an aqueous organic waste is performed, usually, by mixing an activated sludge with the waste to be treated, aerating the mixed liquor in an aeration tank to subject the organic matter in the waste to biodegradation by microorganisms in the activated sludge and separating the sludge from the aerated mixed liquor in a settling tank, whereupon the supernatant is discharged out of the treatment system as a treated water, while the separated sludge is partly returned to the aeration tank as a return sludge and the remainder is exhausted out of the system as excess sludge. In such an activated sludge treatment of an organic matter containing aqueous waste, the organic matter is subjected to biodegradation by the activated sludge in which certain bacteria have come to prevail over others. However, in some cases, the nature of the raw waste and the conditions of the sludge treatment may facilitate multiplication of filamentous microorganisms, which can cause bulking or scumming of the sludge.

Bulking is a phenomenon in which filaments link multiple flocs, thus creating buoyancy from increased surface area whereby the sludge loses its settling ability. When bulking occurs, the separation of the sludge in the settling tanks becomes difficult and a part of the sludge may be discharged out of the system with the treated water. In addition, a sufficient amount of the returned sludge may not be preserved and the biotreatment performance can be decreased.

Various general biocides have been used to prevent the multiplication of filamentous microorganisms. However, the general biocides also suppress multiplication of desirable non-filamentous microorganisms as well as having an undesirable influence on humans and animals if discharged to the environment. The use of such general biocides results in a kill/recovery type cycle in an activated sludge process. Surfactants have been employed to inhibit the growth of filamentous species. See for example, U.S. Pat. No. 5,536,410. These agents show limited effect on the floc-forming bacteria and appear to preferentially inhibit growth of filaments. Many surfactants show bacterial inhibition effects in many applications. Some surfactants show strong activity, while others possess properties that are undesirable to mixed bacterial cultures.

Most bacteria contain capsules or Glycocalyces attached to the outer proximity. This layer contains polysaccharides with charged sugar components, e.g. uronic acids. This loosely structured exopolymer layer is stabilized by divalent metal cations like calcium and magnesium, although other metals like iron may also play a role in stabilizing these polymer layers. This outer layer controls diffusion of materials to and from the bacterial cell wall, and the diffusion properties will be species specific where some bacteria will limit all small molecules while others will limit only larger protein or polymeric materials above a certain molecular weight. The concentration and availability of these divalent metals will effect the structure, and therefore the diffusivity of these exopolymer layers, and this will determine the efficacy of any growth inhibiting additive that may be employed.

Some bacteria like typical floc-forming bacteria will have capsular layers that account for as much as half the volume occupied by the bacteria, while other will have limited layers that occupy smaller volumes. Most filamentous bacteria have smaller capsular layers and are more easily disrupted by additives that have an affinity for divalent cations contained in this exopolymer layer. Filamentous bacteria grow in long strands and often times share a common sheath that traverses the length of the filament. Proper bacterial membrane transport is controlled by metal concentrations on or near the membrane wall. We believe that the combination of the present invention disrupts the stability of the exopolymer layer and allows greater diffusion towards the cell wall. Filamentous bacteria with the smaller exopolymer layer will be more susceptible to this activity, while floc-formers with a larger exopolymer layer and growing in larger flocs will be less effected by the treatment of the present invention. Additionally, filaments growing out from an activated sludge floc will have a greater surface area for chemical interaction and will be more effected by the treatment combination.

### SUMMARY OF THE INVENTION

The present invention provides an effective method for inhibiting bulking of biological waste treatment systems such as aqueous activated sludge systems by controlling the multiplication of filamentous bacteria. The method of the present invention comprises treating a biological waste treatment system such as an activated sludge system with a combination of a divalent metal (such as calcium or magnesium) active species and a surfactant. The surfactant inhibits growth of filamentous species. The components of the treatment combination of the present invention are selected such that harmful influence on useful, floc-forming bacteria as well as humans and animals is minimized.

### DETAILED DESCRIPTION OF THE PREFERRED EMBODIMENTS

The present invention relates to a treatment combination, which effectively inhibits bulking in aqueous biological waste treatment systems such as an activated sludge systems by filamentous bacteria. The treatment combination is added to an aqueous activated sludge system in an amount effective to inhibit bulking. By inhibit, it is meant not only the exclusion of the occurrence of the phenomena of bulking but also suppression of a developed or the progression of an existing bulking of sludge.

The treatment combination of the present invention comprises a biologically active surfactant and a divalent metal (such as calcium or magnesium) active species. Biologically active surfactants are those surfactants which inhibit growth of microorganisms. Ionic surfactants both cationic and anionic show some activity towards most bacteria. However, the non-specificity of this activity along with practical complications of the charged surface-active species in waste treatment systems render cationic and anionic surfactants undesirable. Nonionic surfactants are preferred for use in waste treatment systems because they exhibit fewer formulatory or application limitations. Many nonionic surfactants exhibit biological activity of varying strengths. As a practical matter, environmental concerns may effect the selection of the preferred nonionic surfactants in accordance with the present invention. For example, alkyl phenolethoxylates have demonstrated the desired selective growth inhibition properties desired in the present invention. However, alkyl phenolethoxylates currently exhibit increased environmental concerns with respect to simple alkylethoxylates and/or mixtures thereof. Accordingly, alkyl phenolethoxylates are not the preferred surfactants of the present invention. The preferred nonionic surfactant of the present invention is a simple nonionic surfactant that is easily biodegraded in a biological waste system and contains no nitrogen or phosphorus components. Exemplary alkylethoxylate nonionic surfactants within the scope of the present invention include Neodol available from Shell Chemicals, Tergitol available from Union Carbide and Surfonic type surfactants such as Surfonic DA, Surfonic EH-2, EH-9 and Surfonic L series available from Huntsman Chemical Company. The preferred nonionic surfactants in accordance with the present invention include Surfonic L24-7 and Tergitol 155-9.

The divalent metal (including but not limited to calcium or magnesium) active species of the combination of the present invention comprises agents which are effective at inhibiting the formation and/or deposition of mineral scale forming materials such as calcium and/or magnesium oxylate, sulfate, and carbonate. Exemplary divalent metal active species in accordance with the present invention include but are not limited to phosphonates; hydroxyethylidine diphosphonic acid; 2-phosphonic butane-1,2,4 tricaroboxylic acid; amino phosphonates; ter-, co-, or homopolymers of acrylic acids, maleic acids, or epoxysuccinic acids such polyepoxysuccinic acid; ethylene diamine tetraacetic acid; and mixtures thereof. Within the present application, these materials will be referred to as calcium active species due to its prevalence as a scale forming species in aqueous systems. However, the term calcium active species as used herein should be interpreted to refer to the general class of divalent metal active species.

The treatment combination of the present invention can be added alone or in combination to an activated sludge system to be treated. The treatment combination is preferably added in combination as an aqueous concentrate having from about 5 to about 250,000 parts per million surfactant and 5 to about 250,000 parts per million divalent metal active species. The aqueous concentrate can be added to the incoming wastewater, sludge basin, clarifier or return activated sludge line of the activated sludge system in amount to provide for a concentration of 5 to about 1000 parts per million of surfactant and about 5 to about 1000 parts per million of divalent metal active species in the activated sludge system.

The present invention will now be further described with reference to specific examples. These examples are exemplary and do not limit the scope of the present invention as defined in the claims. In the examples, percent values are given on a weight basis.

### EXAMPLES

In the following Examples, the pure culture studies used a typical filamentous bacteria (Sphaerotilus natans, ATCC 15291) and a typical floc-forming bacterium (Pseudomonas aeruginosa, ATCC 10145). Each bacterium was grown in a specific media and observed by measuring oxygen uptake rates with a Challenge Environmental respirometer. Oxygen uptake rate measurements were supplemented with a total suspended solids (TSS) and turbidity measurements to determine the extent and the mode of bacterial growth. All studies were performed by first allowing the bacteria to reach an endogenous phase, as indicated by a constant oxygen uptake rate, and then spiking the culture with a fixed volume of media that contained a specific amount of the additive being tested. All tested compounds were being applied at 5 or 10 parts per million final concentration in the respirometer reactors. Various calcium active species and surfactants were tested alone and in combination.

### Example 1

The growth of Sphaerotilus natans, a typical filamentous organism, in a Glucose/Peptone/Yeast media at 25° C. was studied. Respirometry data was monitored with a computer data acquisition system. Turbidity and total suspended solids were measured at the completion of the run. The surfactant, Surfonic L24-7 (an ethoxylated alcohol surfactant: C12-C16 alcohol with 7 moles of ethylene oxide), was tested alone, and in combination with several calcium active agents ethylenediaminetetraacetic acid (EDTA), hydroxyethylidene diphosphonic acid (HEDP), and poly(epoxysuccinic acid) (PESA). The test runs included a Blank (no treatment) as well as 10 ppm surfactant, 10 ppm calcium active species and a combination of 10 ppm surfactant plus 10 ppm calcium active species. Tests were run in duplicate and Table 1 summarizes the averages of turbidity and total suspended solids percent reduction (TSS) for duplicate runs.

Table 3 summarizes the averages of oxygen uptake rate reduction at 6 and 12 hours post feed of treatment. Because bacterial cultures are problematic and it is difficult to produce duplicate growth results, duplicate sets of tests with the surfactant Surfonic L24-7 and the calcium active species PESA were performed. Table 1 summarizes the results of % reduction relative to the blank for turbidity and Total Suspended Solids (TSS) from the duplicate tests. Table 3 summarizes the results of oxygen uptake testing with “Test 1” corresponding to the TSS testing in Table 1 and “Test 2” corresponding to the TSS testing in Table 2.

TABLE 1
(Sphaerotilus natans) Percent Change In Turbidity and TSS

| | Average Turbidity | Average TSS |
|---|---|---|
| | (% change) | (% change) |
| Blank | — | — |
| L24-7 | 14.2% | 15.1% |
| EDTA | 7.32% | −2.52% |
| L24-7 & EDTA | 28.6% | 38.8% |
| HEDP | 25.1% | 35.6% |
| L24-7 & HEDP | 63.0% | 52.2% |
| PESA | 38.6% | 19.8% |
| L24-7 & PESA | 66.8% | 54.0% |

TSS = total suspended solids
% change = % reduction from the blank

TABLE 2
(Sphaerotilus natans) Percent Change In Turbidity and TSS

| | Average Turbidity | Average TSS |
|---|---|---|
| | (% change) | (% change) |
| Blank | — | — |
| L24-7 | 27.0% | 23.0% |
| PESA | 5.88% | 10.7% |
| L24-7 & PESA | 7.09% | 37.8% |

TSS = total suspended solids
% change = % reduction from the blank

TABLE 3
Oxygen Uptake Rate [mg.O₂/hr] (Sphaerotilus natans)

| | Test 1 @ | Test 1 @ | Test 2 @ | Test 2 @ |
|---|---|---|---|---|
| | 6 hrs | 12 hrs | 6 hrs | 12 hrs |
| Blank | — | — | — | — |
| L24-7 | 79.5% | 11.8% | 49.6% | −5.0% |
| EDTA | −6.84% | −7.87% | | |
| L24-7 & EDTA | 73.7% | 84.3% | | |
| HEDP | 61.6% | 65.2% | | |
| L24-7 HEDP | 75.8% | 74.2% | | |
| PESA | 54.7% | 58.4% | 18.9% | 15.0% |
| L24-7 & PESA | 75.3% | 80.3% | 69.4% | 5.71% |

% = % reduction from the blank

Table 1 shows that the combination of a calcium active species (EDTA, HEDP, and PESA) with the surfactant reduced the turbidity and suspended solids of the exposed cultures. Individual additives could reduce the turbidity or suspended solids, but the combination of the two resulted in a reduction of both turbidity and suspended solids. This effect was observed with the three tested calcium active species. Tables 1 and 2 list turbidity and suspended solid results from a duplicate run with PESA and the surfactant. Again, the combination of the two gave overall superior results although the surfactant alone did produce slightly lower turbidity than the combination. This small difference was balanced by a superior reduction in suspended solids, again indicating that the combination had overall superior activity.

Table 3 shows the % reduction oxygen uptake rates relative to the blank at both 6 and 12 hours. A lower oxygen uptake indicates a lower growth rate while a zero oxygen uptake indicates a dead culture. Data in Table 3 shows that the combination of the calcium active species and the surfactant produces greater reduction in growth rate than with either of the additives added individually. This effect continued for the duration of the run. The effect of the surfactant alone was strongest at 6 hours but diminished between 6 and 12 hours while the calcium active species remained active for the duration of the run. When the calcium active species and the surfactant were combined, the effect was stronger than observed with the individual additives and remained strong throughout the observed 12 hours. The duplicate test run measuring oxygen uptake rate (Table 3) showed the same effect at 6 hours but with less dramatic differences at 12 hours. Bacterial growth follows generational patterns and will depend on multiple environmental factors. The results of these tests show enhanced growth inhibition activity when the surfactant is combined with the calcium active species.

### Example 2

The growth of Pseudomonas aeruginosa, a typical floc-forming organism, in a Glucose/Peptone/yeast media at 30° C. was studied. Respirometry data was monitored with a computer data acquisition system. Turbidity and Total Suspended Solids were measured at the completion of the runs. A nonionic surfactant, Surfonic L24-7 at 10 parts per million was tested alone and in combination with the calcium active species PESA at 10 parts per million. All runs were performed in duplicate along with a Blank (no treatment) run. Table 4 summarizes the results of % reduction in average turbidity and Total Suspended Solids (TSS) while Table 5 summarizes the % reduction in average oxygen uptake rates at 6 and 12 hours post-shot feed.

TABLE 4
(Pseudomonas aeruginosa) Percent Change In Turbidity and TSS

| | Average Turbidity (% change) | Average TSS (% change) |
|---|---|---|
| Blank | — | — |
| L24-7 | 1.78% | 52.6% |
| PESA | −4.14% | 0% |
| L24-7 & PESA | −29.0% | 44.7% |

TSS = total suspended solids
% change = % reduction from the blank

TABLE 5
Percent Change in Oxygen Uptake Rate [mg.O₂/hr]
(Pseudomonas aeruginosa)

| | @ 6 hrs | @ 12 hrs |
|---|---|---|
| Blank | — | — |
| L24-7 | −9.68% | 25.4% |
| PESA | −19.4% | −10.5% |
| L24-7 & PESA | −35.5% | −16.4% |

% = % reduction from the blank

This typical floc-forming bacterium did not grow well in these particular environmental conditions but the results showed how a combination of a surfactant and calcium active agent effected the growth of a typical floc-forming bacterium. The turbidity from the single component runs were similar while the suspended solids were different. The surfactant produced lower suspended solids and this was carried over into a combination run with only a slight change to higher solids. The relative oxygen uptake rates show that when the calcium active species is present by itself or in combination with the surfactant there is an increase in oxygen uptake rate. It is theorized that this maybe due to two effects. First there maybe a metabolic shift in the population to higher respiration and lower cell production. Second, there maybe a shorter growth inhibition effect with this combination that results in a short interruption in self-production. Since suspended solid and turbidity measures at the end of the run are cumulative, any interruption in cell growth will result in a lower final numbers but the increased oxygen uptake rates indicates that any interruption would have been short-lived.

### Example 3

Calcium activity in aqueous systems can be due to sequestering, chelation or crystal modification in aqueous systems. Some or all of these mechanisms may also hold for interaction with divalent metal in biological systems. The calcium active species tested above (EDTA, HEDP, and PESA) can be calcium sequestering treatments. Testing of a calcium chelating agent, ethylene glycol bis-(B-aminoethyl ether)-N,N′-tetraacetate (EGTA, ACS #133368-13-3) was undertaken. Runs as described above in Example 1 were undertaken with the nonionic surfactant Surfonic L24-7 and EGTA alone and in combination. The treatment agents were added at a concentration of 5 parts per million and again at 10 parts per million. Table 6 summarizes the results of turbidity and total suspended solids testing for 5 ppm (Experiment 4)and 10 ppm (Experiment 5)runs, while Table 7 summarizes the % reduction in oxygen uptake rates at 6 and 12 hours post shot feed for these runs.

TABLE 6
(Sphaerotilus natans) Percent Change In Turbidity and TSS

| | Average Turbidity | Average TSS |
|---|---|---|
| | (% change) | (% change) |
| Experiment 4 | | |
| Blank | — | — |
| L24-7 (5 ppm) | 26.8% | −1.24% |
| EGTA (5 ppm) | 24.9% | 0% |
| L24-7 (5 ppm) & | 15.0% | 1.74% |
| EGTA (5 PPM) | | |
| Experiment 5 | | |
| Blank | — | — |
| L24-7 (10 ppm) | 8.33% | 17.5% |
| EGTA (10 ppm) | 18.4% | 4.89% |
| L24-7 (10 ppm) & | 25.4% | 22.7% |
| EGTA (10 ppm) | | |

TSS = total suspended solids
% = % reduction from the blank

TABLE 7
Percent Change in Oxygen Uptake Rate [mg.O₂/hr]
(Sphaerotilus natans)

| | @ 6 hrs | @ 12 hrs | @ 6 hrs | @ 12 hrs |
|---|---|---|---|---|
| | (5 ppm) | (5 ppm) | (10 ppm) | (10 ppm) |
| Blank | — | — | — | — |
| L24-7 | −8.33 | 1.47% | 31.2% | 33.4% |
| EGTA | −3.67% | 14.7% | −10.8% | 12.9% |
| L24-7 & EGTA | −15.7% | 0.882% | 67.5% | 81.1% |

% = % reduction from the blank

The data in Tables 6 and 7 indicates that for this treatment combination a concentration of greater than 5 parts per million of each component is required to provide efficacy for this particular bacterium. The activity observed with this calcium active agent (a chelating agent) is similar to that observed with the previously tested calcium active sequesterants.

### Example 4

Additional testing was undertaken for combinations of the calcium active agent PESA and surfactants other than Surfonic L24-7. Surfactants listed in Table 8 were employed in the testing. Anionic, cationic as well as nonionic surfactants were tested.

TABLE 8
Supplemental Surfactants.

| Name | Composition | CAS # | Charge |
|---|---|---|---|
| Polystep B-3 | Sodium lauryl sulfate | 151-21-3 | Negative |
| | | | (anionic) |
| Mazeen C-15 | Polyoxyethylene 15 | 61791-14-8 | Positive |
| | cocoamine | | (cationic) |
| Triton X-100 | Ethoxylated alkyl phenol | 9036-19-5 | Zero (neutral) |
| Tergitol 15S-9 | Ethoxylated alcohol | 84133-50-6 | Zero (neutral) |
| Pegosperse | Glycol ester | 141-20-8 | Zero (neutral) |
| 100-L | | | |

The combinations of PESA and the surfactants were tested as described above in Example 1. All treatment agents were added at a concentration of 10 parts per million. The surfactants were tested individually and in combination with PESA, a Blank was also run as a control. Tables 9 summarize the results of testing of turbidity, total suspended solids and Table 10 summarizes % reduction in oxygen uptake at 6 and 12 hours post shot-feed of the surfactants alone with Sphaerotilus natans bacterium. The reported results for turbidity and total suspended solids are averages of duplicate test runs. A Blank (no treatment) test run was performed as a control.

TABLE 9
(Sphaerotilus natans) Percent Change In Turbidity and TSS

| | Average Turbidity (% change) | Average TSS (% change) |
|---|---|---|
| Blank | — | — |
| Polystep B-3 | 9.0% | 6.8% |
| Blank | — | — |
| Mazeen C-15 | 18.7% | −20.9% |
| Blank | — | — |
| Triton X-100 | 2.4% | 16.3% |
| Blank | — | — |
| Tergitol 15 S-9 | 5.5% | −2.7% |
| Blank | — | — |
| Pegosperse | −44.1% | 7.8% |
| 100-L | | |

TSS total suspended solids
% = % reduction from the blank

TABLE 10
Percent Change in Oxygen Uptake Rate [mg.O₂/hr]
(Sphaerotilus natans)

| | O₂ uptake Rate @ 6 hrs | O₂ uptake rate @ 12 hrs |
|---|---|---|
| Blank | — | — |
| Polystep B-3 | 14.0% | 12.5% |
| Blank | — | — |
| Mazeen C-15 | −4.3% | −4.1% |
| Blank | — | — |
| Triton X-100 | 31.1% | −3.0% |
| Blank | — | — |
| Tergitol 15 S-9 | −7.5% | −21.6% |
| Blank | — | — |
| Pegosperse | 3.9% | −9.5% |
| 100-L | | |

% = % reduction from the blank

Table 11 summarizes the results of testing of turbidity and oxygen uptake rate at 6 and 12 hours post shot-feed for the surfactants alone with Pseudomonas aeruginosa bacterium. The Pseudomonas aeruginosa cultures were grown as dilute suspensions that could not be retained on the glass fiber filters used to determine total suspended solids. Therefore, total suspended solid measurements were not made for this bacterium. The results for turbidity are averages of duplicate test runs. The Blank (no treatment) runs were performed as controls.

TABLE 11
(Pseudomonas aeruginosa) Percent Change in Average Oxygen
Uptake Rate [mg.O₂/hr] and Turbidity Results

| | O₂ uptake Rate | O₂ uptake rate | Average Turbidity |
|---|---|---|---|
| | @ 6 hrs | @ 12 hrs | (NTU) |
| Blank | — | — | — |
| Polystep B-3 | 12.5% | 17.9% | 12.7% |
| Blank | — | — | — |
| Mazeen C-15 | −10.0% | −23.2% | −11.3% |
| Blank | — | — | — |
| Triton X-100 | −9.2% | −8.2% | −0.5% |
| Blank | — | — | — |
| Tergitol 15 S-9 | 0.0% | 0.0% | 28.3% |
| Blank | — | — | — |
| Pegosperse | −24.5% | −33.8% | −4.4% |
| 100-L | | | |

% = % reduction from the blank

### Example 5

Tables 12, 13 (Sphaerotilus natans) and 14 (Pseudomonas aeruginosa) summarize the results of testing with the surfactants listed in Table 8 with the calcium active species PESA. Test procedures were similar to that described above with respect to Example 1. Changes in the procedure comprised a reduction in the volume of the starting media and an increase in the respirometer stirring rate. These modifications resulted in the maintenance of the pH of the reactors between pH 7 and pH 8. Thus, direct comparisons of growth rates are difficult, however; the relative performance of one surfactant versus another can be made.

TABLE 12
(Sphaerotilus natans) Percent Change In Turbidity and TSS

| | Average TSS | Average Turbidity |
|---|---|---|
| | (% change) | (% change) |
| Blank | — | — |
| PESA | 0.0% | −10.0% |
| PESA & Polystep | 11.6% | 9.1% |
| B-3 | | |
| PESA & Mazeen | −2.3% | −6.3% |
| C-15 | | |
| PESA & Triton | −0.4% | −1.7% |
| X-100 | | |
| PESA & Tergitol | 11.2% | 11.7% |
| 15 S-9 | | |
| PESA & Pegosperse | 4.7% | −9.5% |
| 100-L | | |
| PESA & Surfonic | 7.8% | 10.4% |
| L24-7 | | |

(%) Shows percent decrease from blank.

TABLE 13
Percent Change in Oxygen Uptake Rate [mg.O₂/hr]
(Sphaerotilus natans)

| | O₂ uptake Rate | O₂ uptake rate |
|---|---|---|
| | @ 6 hrs | @ 12 hrs |
| Blank | — | — |
| PESA | −2.4% | −3.3% |
| PESA & Polystep B-3 | 28.6% | 32.2% |
| PESA & Mazeen C-15 | −10.2% | −1.9% |
| PESA & Triton X-100 | 10.8% | 15.1% |
| PESA & Tergitol 15 | 40.6% | 40.3% |
| S-9 | | |
| PESA & Pegosperse | −21.5% | −18.6% |
| 100-L | | |
| PESA & Surfonic | 11.5% | 22.7% |
| L24-7 | | |

(%) Shows percent decrease from blank.

PESA alone did not significantly effect the solids or oxygen uptake rates, but did produce a small increase in turbidity. Mazeen C-15 plus PESA stimulated the growth of this bacterium and resulted in higher 02 uptake rates, turbidities, and solids. Pegosperse 100-L resulted in a pattern similar to Mazeen C-15, although it did reduce the suspended solids slightly. Triton X-100 reduced the oxygen uptake rate and marginally changed the solids and turbidity, but this small change in solids and turbidity is not significant. Polystep B-3 reduced the oxygen uptake rate, solids and the turbidity when combined with PESA, producing the desired effect on this bacterium. The results from Tergitol 15 S-9 and Surfonic L24-7 also show the desired pattern with a decrease in O₂ uptake rate and a decrease in suspended solids and turbidity. These later two surfactants are similar nonionic surfactants, while the Polystep B-3 is an anionic surfactant.

Growth of Pseudomonas aeruginosa is not as problematic as the Sphaerotilus natans bacterium, and required no modification from the previous experimental design. Testing with the calcium active species PESA in combination with the surfactants listed in Table 8 was undertaken. Table 14 summarizes the results for 02 uptake and turbidity. Again, the results are the average from duplicate runs, and the numbers indicate the percent decrease relative to the blank.

TABLE 14
(Pseudomonas aeruginosa) Percent Change in Average Oxygen
Uptake Rate [mg.O₂/hr] and Turbidity Results

| | O₂ uptake | O₂ uptake | Average Turbidity |
|---|---|---|---|
| | Rate @ 6 hrs | rate @ 12 hrs | (NTU) |
| Blank | — | — | — |
| PESA | −32.3% | −47.2% | −4.3% |
| PESA & Polystep | −9.7% | −12.6% | 2.0% |
| B-3 | | | |
| PESA & Mazeen | −5.7% | −13.5% | 7.8% |
| C-15 | | | |
| PESA & Triton | −27.4% | −31.5% | 7.0% |
| X-100 | | | |
| PESA & Tergitol | 0.8% | 3.6% | 10.5% |
| 15 S-9 | | | |
| PESA & Pegosperse | −5.6% | −11.7% | 13.3% |
| 100-L | | | |
| PESA & Surfonic | −11.3% | −15.3% | 9.4% |
| L24-7 | | | |

(%) Shows percent decrease from blank.

The results of the above examples show that the combination of a nonionic and/or anionic surfactant with a calcium active species selectively inhibits the growth of filamentous bacterium while stimulating the growth of floc-forming bacteria, results desirable in controlling bulking of an activated sludge system. The combination of calcium active species and a cationic surfactant did not exhibit these desirable properties. Additionally, the combination of the anionic surfactant (Polystep B-3) with PESA reversed the effect of the surfactant alone seen in Table 11 of Example 4.

While the present invention has been described with reference to particular embodiments thereof, it is apparent that numerous other forms and modifications of the invention will be obvious to those skilled in the art. The appended claims in this invention generally should be construed to cover all such obvious forms and modification which are within the true spirit and scope of the present invention.

What is claimed is:

1. A method for inhibiting filamentous bacteria induced bulking of a biological waste treatment system comprising adding to a biological waste treatment system a treatment combination comprising at least one anionic or nonionic surfactant in combination with at least one divalent metal active species.

2. The method of claim 1, wherein said at least one divalent metal active agent is selected from the group consisting of phosphonates, hydroxyethylidine diiphosphonic acid, 2-phosphonic butane-1,2,4 tricarboxylic acid, hydroxyethylidene diphosphonic acid, amino phosphonates, ter-, co-, or homopolymers, of acrylic acids, maleic acids, or epoxysuccinic acids such polyepoxysuccinic acid, ethylene diamine tetraacetic acid and mixtures thereof.

3. The method of claim 1, wherein said at least one divalent metal active agent is selected from the group consisting of polyepoxysuccinic acid, hydroxyethylidine diiphosphonic acid, ethylene di tetraacetic acid and mixtures thereof.

4. The method of claim 1, wherein said at least one anionic or nonionic surfactant is an alkyl ethoxylate.

5. The method of claim 1, wherein said combination is added to said biological waste treatment system so as to present in a concentration of from about 5 to about 1,000 parts per million.

6. A method of inhibiting filamentous bacteria growth in an aqueous system comprising adding to said aqueous system a treatment combination comprising at least one anionic or nonionic surfactant in combination with at least one divalent metal active species.

7. The method of claim 6, wherein said at least one divalent metal active agent is selected from the group consisting of phosphonates, hydroxyethylidine diiphosphonic acid, 2-phosphonic butane-1,2,4 tricarboxylic acid, hydroxyethylidene diphosphonic acid, amino phosphonates, ter-, co-, or homopolymers, of acrylic acids, maleic acids, or epoxysuccinic acids such polyepoxysuccinic acid, ethylene diamine tetraacidic acid and mixtures thereof.

8. The method of claim 6, wherein said at least one divalent metal active agent is selected from the group consisting of polyepoxysuccinic acid, hydroxyethylidine diiphosphonic acid, ethylene di tetraacetic acid and mixtures thereof.

9. The method of claim 6, wherein said at least one anionic or nonionic surfactant is an alkyl ethoxylate.

10. The method of claim 6, wherein said combination is added to said aqueous system so as to present in a concentration of from about 5 to about 1,000 parts per million

11. A method for reducing turbidity and total suspended solids in a biological waste treatment system comprising adding to a biological waste treatment system a treatment combination comprising at least one anionic or nonionic surfactant in combination with at least one divalent metal active species.

12. The method of claim 11, wherein said at least one divalent metal active agent is selected from the group consisting of phosphonates, hydroxyethylidine diiphosphonic acid, 2-phosphonic butane-1,2,4 tricarboxylic acid, hydroxyethylidene diphosphonic acid, amino phosphonates, ter-, co-, or homopolymers, of acrylic acids, maleic acids, or epoxysuccinic acids such polyepoxysuccinic acid, ethylene diamine tetraacetic acid and mixtures thereof.

13. The method of claim 11, wherein said at least one divalent metal active agent is selected from the group consisting of polyepoxysuccinic acid, hydroxyethylidine diiphosphonic acid, ethylene di tetraacetic acid and mixtures thereof.

14. The method of claim 11, wherein said at least one anionic or nonionic surfactant is an alkyl ethoxylate.

15. The method of claim 11, wherein said combination is added to said biological waste treatment system so as to present in a concentration of from about 5 to about 1,000 parts per million.
